(19) United States
(12) Patent Application Publication
(10) Pub. No.: US 2009/0204518 A1
(43) Pub. Date: Aug. 13, 2009

(54) System for electronically implementing a business transaction between a payee and a payor

(76) Inventor: Andras Vilmos, Budapest (HU)

Correspondence Address: Olson & Cepuritis, LTD., 20 NORTH WACKER DRIVE, 36TH FLOOR, CHICAGO, IL, 60606, US

(21) Appl. No.: 12/322,602

(22) Filed: Feb. 4, 2009

Related U.S. Application Data
(63) Continuation-in-part of application No. 10/432,096, filed on May 20, 2003.
Application No. 10/432,096 is a continuation-in-part of application No. 10/518,951, filed on Sep. 22, 2005, now abandoned.

(30) Foreign Application Priority Data
Nov. 20, 2000 (HU) P 0004604
Jun. 17, 2002 (HU) P 0202003

(51) Int. Cl. G06Q 20/00; H04L 9/32; G06Q 40/00

(52) U.S. Cl. 705/30; 705/75; 705/40

(57) ABSTRACT

A system for electronic implementation of a business transaction between parties thereto is disclosed. The system comprises an operably inter-connectable network which includes a transaction processing unit of a payor selected financial service provider, a transaction processing unit of a payee selected financial service provider, a payor input/output unit operably connectable with the transaction processing unit of the payor selected financial service provider, and a payee input/output unit operably connectable with the transaction processing unit of the payee selected financial service provider. The transaction processing unit of the payor selected financial service provider and the transaction processing unit of the payee selected financial service provider are operably connectable to one another.

### CROSS-REFERENCE TO RELATED APPLICATIONS

This application is a continuation-in-part of co-pending U.S. Ser. No. 10/432,096, filed on May 20, 2003, and U.S. Ser. No. 10/518,951, filed on Sep. 22, 2005, both being incorporated herein by reference in their entireties.

### FIELD OF THE INVENTION

This invention relates to a transaction system for the preparation and execution of a business transaction between a payee and a payor.

### BACKGROUND OF THE INVENTION

Today, with the rapid development of computing and mobile telecommunications, cash-free financial transactions linked to purchases are becoming increasingly widespread and often are realized using some sort of data network. These include account settlement with the assistance of the so-called “POS terminal”, as well as the financial offsetting of purchases made on the Internet. Among others, such solutions can be seen in Hungarian Patent No. HU 218.646, and in International publication No. WO 00/23928.

International publication No. WO 95/12859 relates to the settlement of accounts, the essence of which is that the payee, who issues the invoice, issues the invoice on the basis of data received from the payor and then sends it to the payor's bank, which settles the invoice amount by bank transfer. In general this solution may be used for the continuous settling of public utility invoices.

The disadvantage of this approach, however, is that the settlement of the invoice takes place essentially automatically, so the payor, before the transfer, has no way of checking the correctness of the invoice or of the amount. There is no opportunity to refuse the settlement of the invoice, as the payor only knows about the payment after it has taken place.

A further disadvantage is that the issuer of the invoice has access to the payor's data, which, in a given case, may lead to future abuses.

Apart from the above, another solution is also known, which is based on the various payees and the payors who intend to purchase the payees' products having to sign in at the same third party center, with the third party center recording both parties' data. This center takes part in all sales transactions by using its own database to check and certify the data of the parties participating in the business transaction, it handles their accounts, makes it possible to use various cash-friendly methods, and it checks, maintains updates the client database. Such a solution relating exclusively to the field of e-commerce is described in the abstract of a lecture by PAYS et al. titled “An Intermediation and Payment System Technology” (Computer Networks and ISDN System; North Holland Publishing, Amsterdam, NL; vol. 28. no. 11; 1 May 1996, pages 1197-1206.)

The solution described in WO 99/66436 has a similar theoretical basis. It is based on the fact that various clients provide their data to an authorized central representative, who stores their data, and the business transaction is realized between two registered clients. The representative checks and confirms the data and also carries out the financial settlement of the transaction.

U.S. Pat. No. 5,880,446 discloses a similar centralized server system which reduces the number of steps required for carrying out an electronic transaction between a number of participants (buyer, seller and financial institutions). Before starting an electronic transaction the buyer inputs the necessary information for the transaction to take place, which is then transmitted to the electronic transaction server. The latter retrieves a corresponding electronic transaction procedure from its storage device and distributes a duty procedure to the participants (buyer, seller, financial institutions) the names of which are included in the retrieved electronic transaction procedure. The participants can then execute the received duty procedures.

The disadvantage of the foregoing solutions is that both the payee and the payor need to connect to a predetermined central server, so it is not possible for the parties taking part in the transaction to carry out the transaction via a reliable partner selected by themselves. A disadvantage deriving from this is that the solution results in numerous undesired restrictions and extra costs for both parties.

A further disadvantage is that the payor and the payee must both reveal their confidential data, which—because of the compulsory participation—may result in misuse.

Another disadvantage is that the preliminary checking of the financial transaction and the business transaction cannot be realized during a real-time procedure, which in certain cases makes the payor's and the payee's situation difficult, and unreasonably increases the duration of the business transaction.

The abstract of a lecture by COUSINS et al., titled “InterPay Managing Multiple Payment Mechanisms in Digital Libraries” (Second Annual Conference on the Theory and Practice of Digital Libraries; 11-13 Jun. 1993; pages 1-9; on line accession) relates to a solution similar to the previous one. In this case again there is a central agent between the payor and the payee, which agent replaces the connection between the payor and the payee and decides on their statements made in connection with the transaction whether the transaction and the payment can be realized or not.

The disadvantage of this solution—similarly to the previous one—is that the payor and the payee are not in direct contact when taking part in the realization of the transaction, as a result of which the transaction itself becomes slower and real-time checking and quick payment afterwards cannot be realized, which, taking into consideration aspects of security, would be favorable both for the payor and the payee.

Also known is a practically automatic checking and payment system service which makes the simpler realization of transactions possible exclusively in the case of making purchases through the Internet. This possibility is described in the abstract of a lecture by GIFFORD et al., titled “Payment switches for open networks” (Proceedings of the first usenix workshop of electronic commerce; 11-12 Jul. 1995, New York, USA; pages 69-75, 1995 Berkeley, USA, USENIX Assoc.)

The advantage of this solution is that it minimizes the payee's transaction risks and reliably fulfils the requirement that the payor must in fact pay for the purchased product.

However, its significant disadvantage—apart from only supporting purchases made through the Internet—is that in the course of realizing the transaction the payors are significantly restricted and they lose even the possibility of the safe handling of their own personal data, as they must share their data with a party basically unknown to them.

A transaction system according to the present invention overcomes the disadvantages occurring when executing the cash-free financial transactions. A solution is provided with the help of which personal and important confidential data of the payee and the payor remain secure, inaccessible to unauthorized parties. Also, an authentication procedure can be carried out between the payor and the payee before the actual execution of the financial transaction.

The present invention also makes possible real-time checking before actual payment is realized—without drawing in a third party unknown to both parties and without central identification, checking or authorization—as a result of which the payee is promised by an already known and trusted payee selected party that the purchase price will definitely be settled, while the payor only shares sensitive personal information with an already known and trusted payor selected party. In this way checking and payment can be realized practically at the same time, which significantly reduces the actual transaction time.

### SUMMARY OF THE INVENTION

A transaction system according to the present invention provides communication between the payee and the payor and their respective financial service providers such as financial institutions, e.g., banks and the like, in a novel way and contrary to the currently known solutions.

In one aspect the invention relates to a transaction system for electronically conducting a business transaction in real time between a payor and a payee. The system comprises an operably inter-connectable network which includes:
a transaction processing unit of a payor selected financial service provider;
a transaction processing unit of a payee selected financial service provider;
a payor input/output unit operably connectable with the payor selected financial service provider transaction processing unit; and
a payee input/output unit operably connectable with the payee selected financial service provider transaction processing unit. The transaction processing unit of the payor selected financial service provider is operably connectable to the transaction processing unit of the payee selected financial service provider.
   The payor input/output unit is configured:
to generate a transaction order comprising at least payor identification data, payee identification data and transaction value; and
to transmit the transaction order to the payor selected financial service provider transaction processing unit.
   The transaction processing unit of the payor selected financial service provider is configured:
to receive from the payor a transaction order comprising at least payor identification data, payee identification data and transaction value;
to identify a payee selected financial service provider based on the payee identification data;
to generate a transaction order processing report based on the transaction value and the payor identification data; and
to transmit the transaction order processing report to the payee selected financial service provider.
   The transaction processing unit of the payee selected financial service provider is configured:
to receive from the payor selected financial service provider a transaction order processing report;
to generate a transaction report based on the received transaction order processing report; and
to transmit the transaction report to the payee input/output unit.
   In another aspect the invention relates to a transaction system for the preparation and execution of a business transaction between a payee and a payor, which comprises:
a transaction processing unit (41) of a payor selected financial service provider (40);
a transaction processing unit (51) of a payee selected financial service provider (50);
a payor input/output unit (10); and
a payee input/output unit (20).
   The transaction processing units (41, 51) and the input/output units (10, 20) are adapted to create electronic communication channels (14, 26, 30, 60) between one another.
   The payor input/output unit (10) comprises:
an own-data input part-unit (11);
a payee-data receiving part-unit (12);
a data unification part-unit (13) having a first input (13a) connected to the own-data input part-unit (11), a second input (13b) connected to the payee-data receiving part-unit (12), and an output (13c) operably connectable to the transaction processing unit (41) of the payor selected financial service provider (40) via an electronic communication channel (14).
   The payee input/output unit (20) comprising:
an own-data input part-unit (21);
a transaction-data management part-unit (22);
a data-unification part unit (23) having a first input (23a) connected to the own-data input part-unit (21), a second input (23b) connected to the transaction-data management part-unit (22), and an output operably connectable with the payee-data receiving part-unit (12) of the payor input/output unit (10) via a directed communication channel (30), and
a data-receiving part-unit (25) connectable to the transaction processing unit (51) of the payee selected financial service provider (50) via an electronic communication channel (26).

A transaction system embodying the present invention for the preparation and execution of a business transaction between a payee and a payor can also utilize the same financial service provider as the payor selected financial service provider and the payee selected financial service provider.

Yet another aspect the invention relates to a transaction processing unit for electronically conducting a business transaction in real time between a payor and a payee in which the transaction processing unit is configured:
to receive electronically a transaction order comprising at least payor identification data, payee identification data and transaction value;
to identify a payee selected financial service provider based on the payee identification data;
to generate a transaction order processing report based on the transaction value and the payor identification data;
to establish an electronic communication channel with the payee selected financial service provider; and
to transmit electronically the transaction order processing report to the payee selected financial service provider over the communication channel.

In a further aspect the present invention provides a method for executing a real-time electronic transaction between a payor and a payee. The method comprises establishing an electronic communication network among the payor, the payee, and at least one financial service provider; generating an electronic transaction order which includes transaction value and contact information; transmitting electronically the generated transaction order directly to a financial service provider selected from said at least one financial service provider utilizing the electronic communications network; processing the transaction order at the selected financial service provider; and thereafter transmitting a result based on said processing electronically from the selected financial service provider to a member of the group consisting of payee and payee's designee, utilizing the electronic communication network.

### BRIEF DESCRIPTION OF THE DRAWINGS

### In the Drawings,

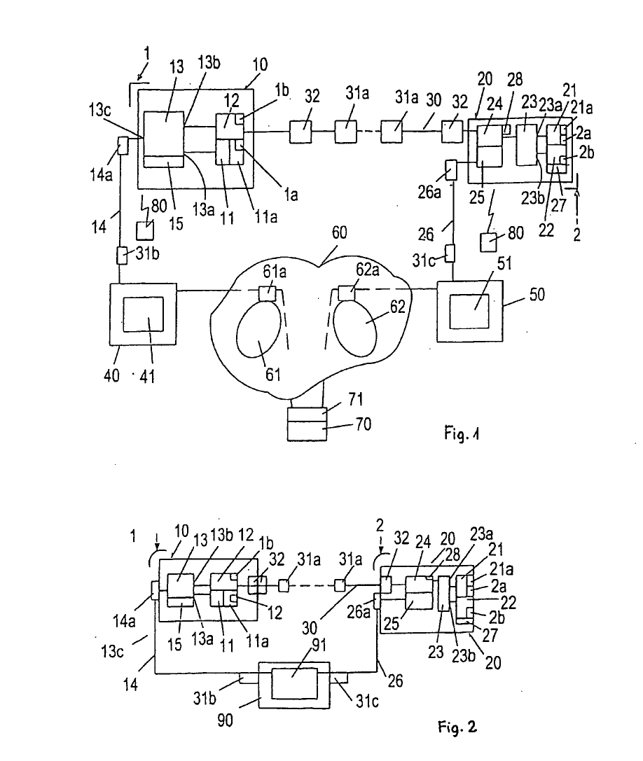

FIG. 1 is a block diagram of an illustrative communication network arrangement of the transaction system according to the invention; and

FIG. 2 is another illustration of the transaction system embodying the present invention.

### DESCRIPTION OF PREFERRED EMBODIMENTS

In a preferred transaction system according to the invention one or more data centers are connectable into the communication network. All of the data centers in the communication network so formed are equipped with communication devices for receiving, processing and forwarding of information.

A data-transmission and operation-performing unit suitable for receiving, processing and forwarding information is also provided into the communication network. Optionally, the data-transmission and operation-performing unit can be linked to an accounting bank, if desired.

A data-transmission channel between the payor input/output unit and the transaction processing unit belonging to the payor's financial service provider such as a financial institution, e.g., a bank and the like, is supplied with at least one wireless signal-transmission device. The data-transmission channel between the payee input/output unit and the transaction processing unit belonging to the payee's financial service provider such as a financial institution is likewise supplied with at least one wireless signal-transmission device.

In one preferred embodiment of the transaction system, data encryption unit is operably associated with each input/output unit, in particular the communication network between the payee's financial service provider and the payor's financial service provider, and/or the data-transmission channel between the payor input/output unit and the payor's financial service provider and/or the data-transmission channel between the payee input/output unit and the payee's financial service provider have one or more encryption part-units.

Preferably the own-data input part-unit of the payor input/output unit comprises an own-data register for storing inputted payor identification data.

Preferably the own-data input part-unit of the payee input/output unit comprises an own-data register for storing inputted payee identification data.

Preferably the payee input/output unit also has a transaction identifier producing module and a payee-data receiving part-unit as well.

Preferably the payor input/output unit includes an information-receiving part-unit for receiving data from the transaction processing unit of the payor selected financial service provider.

In a still further embodiment of the transaction system, the directed data channel between the payor input/output unit and the payee input/output unit has at least one wireless signal-transmission device built in.

In yet another embodiment of the invention, the payor input/output unit and/or the payee input/output unit are supplemented with a wireless signal-transmission device.

An important advantage provided by the transaction system according to the invention is that due to the new use of a payor input/output unit a payee input/output unit, and a direct connection between the two, is not necessary for the payee and the payor to exchange confidential, personal data in order to complete the transaction. As a consequence, the risk of an unauthorized person being able to access and abuse this information is eliminated. In other words, the bank account number, personal identification number or password, and other similar data, are protected.

Another advantage is that, due to the new transaction system, the preparation of the financial transaction, in other words, the checking and authentication in advance of the money transfer, can be completed in a relatively short time. Thus, the purchase can be seen as a real-time sale, which greatly increases the payor's and payee's feeling of security. Neither the payor nor the payee suffers loss or discomfort in connection with the execution of the business deal.

Referring to the drawings, FIG. 1 shows an example of the transaction system according to the invention. In this embodiment the transaction system comprises a transaction processing unit 41 of a payor selected financial service provider 40, and a transaction processing unit 51 of payee selected financial service provider 50. Units 41 and 51 are connectable via a communication network 60 by establishing an electronic communication channel therebetween. The communication network 60 may comprise devices which preferably belong to the transaction system. For example the communication network 60 may comprise a first data center 61 having communication device 61a via which it may be connected with the transaction processing unit 41 of the payor selected financial service provider 40. The communication network 60 may also comprise a second data center 62, which is operably connected to the transaction processing unit 51 of the payee-selected financial service provider 50 via communication device 62a. The data centers 61, 62 and their respective communication devices 61a, 62a may be part of the inventive transaction system, or they may be auxiliary devices, with which the transaction processing units 41, 51 preferably cooperate.

Alternatively, both the transaction processing unit 51 of the payee-selected financial service provider 50 and the transaction processing unit 41 of the payor-selected financial service provider 40 may be operably connected to the communication device 61a of the first data center 61.

The first data center's 61 communication device 61a and the second data center's 62 communication device 62a may optionally be connected to an accounting bank 70 via a data-transmission and operation-performing unit 71. Numerous data centers similar to the data centers 61 and 62 may appear in the communication network 60, all of which can be connected to financial service providers similar to the payor-selected financial service provider 40 and the payee-selected financial service provider 50. For the sake of simplicity, however, only one such payor-selected financial service provider 40 and one such payee selected financial service provider 50 are shown.

For the appropriate operation of the transaction system according to the invention it is not absolutely necessary to have the accounting bank 70, but it may be desirable from the point of view of carrying out the transactions. It is not necessary either to include a data center in the transaction system as the payee selected financial service provider and the payor-selected financial service provider may be directly linked to each other or may even be the same entity as will be explained later on.

The communication network 60 may be any kind of communication system. A line data-transmission network, a wireless network, or a combination of these can be utilized for this purpose. Their essence is that, irrespective of their construction, the necessary signal groups at the desired speed and reliability level can be transmitted from the transaction processing unit 41 of the payor-selected financial service provider 40 to the transaction processing unit 51 of the payee-selected financial service provider 50, and back. It is to be understood that various devices known in the art may participate when establishing an electronic communication network between the transaction processing unit 41 of the payor-selected financial service provider 40 to the transaction processing unit 51 of the payee-selected financial service provider 50. The transaction processing units 41 and 51 are typically software applications running on a computer system comprising hardware devices and further software applications. Thus the electronic communication channel is typically established over an operating system, network card and signal transmitting media. In the context of the present invention the electronic communication channel is understood to be an application-to-application communication channel.

FIG. 1 also shows a payor communication means such as a payor input/output unit 10 belonging to the payor 1 and a payee communication means such as a payee input/output unit 20 belonging to the payee 2. The payor input/output unit 10 is physically in the possession or under control of the payor 1, and the payee input/output unit 20 is in the possession or under control of the payee 2.

The input/output units 10, 20 are typically realized in the form of software application that may be installed on a hardware device such as desk computer, laptop, mobile phone, smart phone, palmtop, notepad, etc. in which case all input, output and processing parts of the input/output units 10, 20 are understood to be software interface and software processing components. However, the input/output units 10, 20 may comprise hardware as well. For example, suitable are computer hardware comprising input part-units such as keyboard, mouse; processing part-units such as processor and memory; output part-units such as data outputting and data transmitting components. Similarly the input/output units 10, 20 may be implemented on any other suitable communication means such as mobile phone, smart phone, palmtop, notepad, laptop, etc.

The payor input/output unit 10, and the payee input/output unit 20 are connectable, i.e., temporarily connected, by establishing an electronic communication channel such as the directed data channel 30 depicted in FIG. 1, which is suitable for the transmission of information. The directed data channel 30 is understood to be an application-to-application communication channel realized by various hardware components, which typically do not form part of the transaction system, as explained in connection with the electronic communication channel that can established between the two transaction processing units 41, 51.

In the interest of data protection, the transaction system may comprise encryption part-units 32, which can be included into the directed data channel 30. The encryption part-units 32 may be physically positioned in the directed data channel 30, but they may also be a part of the payor input/output unit 10 and the payee input/output unit 20 as well. The position or relative location of the encryption part-units 32 is unimportant. It is important, however, that by using such encryption part-units 32 the data transmitted over the directed data channel 30 can be protected against unauthorized information acquisition. The directed data channel 30 may also include one or more signal-transmission devices 31a, e.g., radiotelephone, mobile data transmission device, and the like, which make implementation of the communication easier.

In the embodiment illustrated in FIG. 1, the payor input/output unit 10 comprises an own-data input part-unit 11, a payee-data receiving part-unit 12, and a data unification part-unit 13 having a first input 13a connected to the own-data input part-unit 11, and a second input 13b connected to the payee-data receiving part-unit 12. The own-data input part-unit 11 and the payee-data receiving part-unit 12 may be software interfaces or they may be hardware interfaces e.g. the own-data input part-unit 11 may be a human interface (such as keyboard, mouse, touch-screen, etc.) or a portable media interface (such as a portable media reader, a serial, parallel or USB port for receiving data from other electronic devices, etc.), and the payee-data receiving part-unit 12 may be a network card receiving data transmitted over the directed data channel 30.

The own-data input part-unit 11 preferably comprises an own-data register 11a for storing payor identification data 1a inputted via the own-data input part-unit 11.

The data unification part-unit 13 further comprises an output 13c which is connectable with the transaction processing unit 41 of the payor selected financial service provider 40 by establishing an electronic communication channel such as the application to application data-transmission channel 14 depicted in FIG. 1. The data-transmission channel 14—similarly to the previously described electronic communication channels—can be realized over practically any kind of communication system (e.g. transmission line or over a wireless system). The data-transmission channel 14 is suitable for carrying out bi-directional data traffic, and preferably includes an encryption part-unit 14a and may include wireless signal-transmission device 31b.

The task of the encryption part-unit 14a is to protect the information between the payor input/output unit 10 and the payor-selected financial service provider 40 from unauthorized parties. In other words, to create and maintain secure data traffic. In the interest of fast data traffic the wireless signal-transmission device 31b may be a necessary part of the data-transmission channel 14.

The payor input/output unit 10 may preferably comprise an information-receiving part-unit 15 connected to the data-transmission channel 14 thus being provided for handling data transmitted from the payor-selected financial service provider 40.

The own-data input part-unit 11 of the payor input/output unit 10, payee-data receiving part-unit 12, data-unification part-unit 13, and information-receiving part-unit 15 can be integrated into a single device. It can even be formed as a mini computer, which greatly simplifies the positioning and use of the payor input/output unit 10. Alternatively, and as explained before, the payor input/output unit 10 may be a software application.

The payee input/output unit 20 depicted in FIG. 1 includes an own-data input part-unit 21 that has an own-data register 21a containing payee identification data 2a, inputted via the own-data input part-unit 21. The own-data input part-unit 21 may be similar software or hardware interface as explained in connection with the own-data input part-unit 11 of the payor input/output unit 10.

The payee input/output unit 20 further comprises a transaction-data management part-unit 22, which may optionally be equipped with a transaction identifier module 27. The transaction-data management part-unit 22 and the transaction identifier module 27 are typically software components; however, the latter may comprise both software and hardware interface for receiving transaction data 2b.

The payee input/output unit 20 further comprises the data-unification part-unit 23, having a first input 23a connected to the own-data input part-unit 21, and a second input 23b connected to the transaction-data management part-unit 22. The data-unification part-unit 23 has an output which is connectable with the payee-data receiving part-unit 12 of the payor input/output unit 10 via the established directed data channel 30. Preferably a payee-data sending part-unit 24 may be provided in addition at the output of the data-unification part-unit 23, in which case the connection between the output of the data-unification part-unit 23 and the payee-data receiving part-unit 12 of the payor input/output unit 10 is understood to comprise the payee-data sending part-unit 24.

Preferably a payee's data-receiving part-unit 25, and a payor-data receiving part-unit 28 is provided, the latter being in connection with the payee-data sending part-unit 24. The payee's data-receiving part-unit 25 is connectable with the transaction processing unit 51 of the payee selected financial service provider 40 by establishing an electronic communication channel such as the application-to-application data-transmission channel 26 depicted in FIG. 1. The data-transmission channel 6—similarly to the previously described electronic communication channels—can be realized over practically any kind of communication system. The data-transmission channel 26 may advantageously include an encryption part-unit 26a and, in a given case, a wireless signal-transmission device 31c. The wireless signal-transmission device 31c creates the opportunity for the payee input/output unit 20 to be constructed so that it may be moved around, or even be portable.

Also in the interest of easier operation, payee input/output unit 20 may have a wireless signal-transmission member 80, which may be a mobile telephone, and the like. A wireless signal-transmission member 80 may be provided for the payor input/output unit 10 as well, and serves a similar role, thus it may be a mobile telephone, or the like.

The payor input/output unit 10 can be built into the wireless signal-transmission member 80 (e.g. installed as a software application), in which case the wireless signal-transmission member 80 takes over the role of the wireless signal-transmission device 31a. In a preferred embodiment the payor input/output unit 10 is installed on the wireless signal-transmission member 80 and appears to the payor 1 as a service provided on a mobile telephone. This way the payor input/output unit 10 can always be carried by the user. Similarly, the payee input/output unit 20 and the wireless signal-transmission member 80 can be combined into a single, even mobile, device as well.

In another preferred embodiment the payor input/output unit 10 and the payee input/output unit 20 can be individual computers or software applications running on individual computers. This is advantageous if the sale or transaction takes place on the Internet. By implementing the payor input/output unit 10 on a laptop or a notepad the payor input/output unit 10 remains portable.

When using the transaction system according to FIG. 1, the payor 1 inputs the payor identification data 1a required for carrying out the financial transaction into the own-data register 11a of the own-data input part-unit 11 of the payor input/output unit 10. The whole or some of the required payor identification data 1a maybe inputted only once and stored, or it may be inputted individually before or during each electronic transaction. Similarly, the payee 2 loads the payee identification data 2a into the own-data register 21a of the own-data input part-unit of the payee input/output unit 20. The payee identification data 2a comprises data relating to the payee 2 that is essential for the financial transaction to take place (e.g. information identifying the payee selected financial service provider 50, information based on which the payee selected financial service provider 50 can identify the payee or the payee's bank account).

After the payor input/output unit 10 and the payee input/output unit 20 have been loaded in this manner, when the sale or transaction is intended between the payor 1 and the payee 2, transaction data 2b relating to the transaction (such as the transaction value, name/description of the items to be purchased, transaction identification code for the payee, etc.) are provided by the transaction identifier producing module 27 at the payee input/output unit 20. The transaction identifier producing module 27 may generate such transaction data 2b based on information inputted by the payee 2 or by an external software application and the generated transaction data 2b is sent to the transaction data management part-unit 22. The transaction data 2b are, on the one part, stored in the transaction data management part-unit 22 and, on the other part, sent to the data-unification part-unit 23 via the second input 23b of the data-unification part-unit 23.

The payee identification data 2a stored in the own-data register 21a of the own-data input part-unit 21 also goes to the data-unification part-unit 23, only via its first input 23a. From the payee identification data 2a and the transaction data 2b the data-unification part-unit 23 creates a transaction order supplement message comprising at least payee information data 2a for identifying the payee selected financial service provider 50 and for allowing the payee selected financial service provider 50 to identify the payee or at least to communicate with the payee 2. The data-unification part-unit 23 sends the transaction order supplement message to the payee-data sending part-unit 24, which then transmits it to the payee-data receiving part-unit 12 of the payor input/output unit 10 over the established directed data channel 30. The transaction order supplement message is preferably encrypted by the encryption part-units 32 associated with the payee input/output devices 20 and decrypted by the encryption part-units 32 associated with the payor input/output devices 10. The encryption part-unit 32 decodes the message thus providing the transaction information 1b in the payee-data receiving part-unit 12, which contains the parameters characteristic of the sale, e.g., the necessary data for transferring the transaction value (purchase price) to the payee 2.

The payee-data receiving part-unit 12 of the payor input/output unit 10 sends at least the necessary transaction information 1b to the data-unification part-unit 13 via the second input 13b of the data-unification part-unit 13, while it sends at least the payor identification data 1a necessary for identifying the payor 1 by the transaction processing unit 41 of the payor selected financial service provider 40, which is stored in the own-data register 11a of the own-data input part-unit 11 via the first input 13a to the data-unification part-unit 13. The data-unification part-unit 13 creates a transaction order from the payor identification data 1a and the transaction information 1b with the help of which the payor-selected financial service provider 40 is able to identify at least the payor 1, the payee-selected financial service provider 50, and the amount to be transferred, together with any desired additional information.

When the transaction order has been prepared, the data-unification part-unit 13 encrypts the transaction order with the help of the encryption part-unit and sends it via the data-transmission channel 14 to the transaction processing unit 41 of the payor selected financial service provider. Here, on the basis of the transaction order, the payor-selected financial service provider 40 generates a transaction order processing report and sends it to the transaction processing unit 51 of the identified payee-selected financial service provider 50 over the communication network 60, optionally including the first data center 61 and possibly including the second data center 62. The transaction order processing report preferably includes information on whether the transaction can be carried out, e.g. based on the balance of the payor's I account held at the payor selected financial service provider 40.

On the basis of the received transaction order processing report, the transaction processing unit 51 of the payee-selected financial service provider 50 provides a transaction report (which may be the transaction order processing report itself or a report based thereon), determines the payee 2, and sends the transaction report via the established data-transmission channel 26 to the payee input/output unit 20 where it is received by the data-receiving part-unit 25. The transaction report sent to the payee input/output unit 20 may advantageously contain the transaction data 2b sent from the payee 2, thus the content of the message can be checked.

If the data received in the transaction report, especially the amount intended to be transferred, agrees with the data stored in the payee's 2 payee input/output unit 20, then the payee input/output unit 20 sends a reply message encrypted with the help of the encryption part-unit 26a via the data-transmission channel 26 to the payee-selected financial service provider 50, which in turn sends this message back to the payor-selected financial service provider 40. Following this, the payor 1 selected financial service provider 40 can carry out the financial transaction regarding which it sends a confirmation message with the help of the data-transmission channel 14 to the information-receiving part-unit 15 of the payor input/output unit 10.

The transaction report can arrive within a very short time after the transaction order has been sent from the payor input/output unit 10, thus the payee is informed quasi real-time of the intended payment transaction, allowing for quasi real-time purchase to take place. For example the payee 2 may provide on-line services straight away after having received the financial service providers' 40, 50 confirmation of the intended payment (i.e. the transaction report).

Optionally, the payor input/output unit 10 may also send back at least part of the transaction order made by the data-unification part-unit 13, on the one hand to the payee selected financial service provider 40 as explained above, and on the other hand to the payor-data receiving part-unit 28 of the payee input/output unit 20 via the directed data channel 30. This way, later on the original message sent to the payor-data receiving part-unit 28 can be compared with the content of the transaction report based on information sent along the route: payor input/output unit 10—data-transmission channel 14—payor-selected financial service provider 40—communication network 60—payee-selected financial service provider 50—data-transmission channel 26—payee's data-receiving part-unit 25.

FIG. 2 is similar to the transaction system shown in FIG. 1 except that the payor 1 and the payee 2 have selected same financial service provider 90 for the transaction. As a consequence of this, the preparatory message chain prior to the financial transaction is significantly shorter, thus there is no need for the more involved communication network 60 shown in FIG. 1 and discussed hereinabove. In this case the communication network is, in essence, only a virtual communication network established in the communication unit 91 of the financial service provider 90.

The operation of the transaction system according to FIG. 2 is similar to the operation discussed in connection with FIG. 1, with the exception that the transaction order processing report is an internal message provided and used by the common transaction processing unit 91 for creating the transaction report. Although a more simple transaction processing unit could be provided in the case where a common financial service provider 90 is selected by the payor 1 and the payee 2, one of the benefits of the invention is that the applicability of the transaction processing units 41, 51 is not restricted in a way as to require a common financial service provider. Preferably each transaction processing unit 41, 51 may operate both as the transaction processing unit at the payor selected financial service provider 40 and as the transaction processing unit at the payee selected financial service provider 50. Hence when the two financial service providers 40, 50 coincide (referred to as the common financial service provider 90) and consequently the two transaction processing units 41, 51 coincide as well (referred to as the common transaction processing unit 91) the common transaction processing unit 91 serves the role of both the payor selected financial service provider transaction unit 41 and the payee selected financial service provider transaction processing unit 51: the common transaction processing unit 91 receives the transaction order, processes it, based on which it generates a transaction order processing report, which it virtually forwards (i.e. without involving a physical communication network) to its own software component adapted to receive a transaction order processing report when operating as a payee selected transaction processing unit. After this, the common transaction processing unit 91—acting as the payee selected transaction processing unit 51—creates a transaction report on the basis of the transaction order processing report, and sends the transaction report to the payee input/output unit 20.

For the operation of the transaction system, the encryption part-unit 32, the encryption part-unit 14a and the encryption part-unit 26a are optional, and the wireless signal-transmission device 31a, the wireless signal-transmission device 31b and the wireless signal-transmission device 31c are optional but not essential elements. However, their utilization significantly simplifies the use of the transaction system and makes it more secure from the point of view of data protection.

The transaction system according to the invention can be applied well for the reliable and fast preparation and possibly execution of cash-free financial transactions occurring during and in connection with purchases of all kinds.

The foregoing discussion and the drawings are intended to be illustrative, and are not to be taken as limiting. Still other variations and rearrangements of system components are possible and will readily present themselves to those skilled in the art.

1. A transaction system for electronically conducting a business transaction in real time between a payor and a payee, which comprises
a transaction processing unit of a payor selected financial service provider;
a transaction processing unit of a payee selected financial service provider;
a payor input/output unit operably connectable with the payor selected financial service provider transaction processing unit; and
a payee input/output unit operably connectable with the payee selected financial service provider transaction processing unit;
wherein said transaction processing units are operably connectable to one another; the payor input/output unit is configured:
to generate a transaction order comprising at least payor identification data, payee identification data and transaction value, and
to transmit the transaction order to the payor selected financial service provider transaction processing unit;
the transaction processing unit of the payor selected financial service provider is configured:
to receive from the payor a transaction order comprising at least payor identification data, payee identification data and transaction value,
to identify a payee selected financial service provider based on the payee identification data,
to generate a transaction order processing report based on the transaction value and the payor identification data, and
to transmit the transaction order processing report to the payee selected financial service provider; and
the transaction processing unit of the payee selected financial service provider is configured:
to receive from the payor selected financial service provider a transaction order processing report,
to generate a transaction report based on the received transaction order processing report, and
to transmit the transaction report to the payee input/output unit.

2. The transaction system according to claim 1 wherein the payee input/output unit is operably connectable with the payor input/output unit and the payee input/output unit comprises
a first input for receiving payee identification data;
a second input for receiving transaction data containing at least a transaction value;
a data-unification part-unit for creating a transaction order supplement message comprising at least payee identification data and the transaction value; and
a payee-data sending part-unit for transmitting the transaction order supplement message to the payor input/output unit.

3. The transaction system according to claim 2 wherein the payor input/output unit comprises
a first input for receiving payor identification data;
a second input for receiving transaction information containing at least payee identification data and a transaction value; and
a data-unification part-unit for generating the transaction order based on the received payor identification data and the received transaction information.

4. The transaction system according to claim 1 wherein a data encryption unit is operably associated with each input/output unit.

5. A transaction system for the preparation and execution of a business transaction between a payee and a payor, which comprises:
a transaction processing unit (41) of a payor selected financial service provider (40);
a transaction processing unit (51) of a payee selected financial service provider (50);
a payor input/output unit (10); and
a payee input/output unit (20);
the transaction processing units (41, 51) and the input/output units (10, 20) being adapted to create electronic communication channels (14, 26, 30, 60) between one another;
the payor input/output unit (10) comprising:
an own-data input part-unit (11);
a payee-data receiving part-unit (12); and
a data unification part-unit (13) having a first input (13a) connected to the own-data input part-unit (11), a second input (13b) connected to the payee-data receiving part-unit (12), and an output (13c) operably connectable to the transaction processing unit (41) of the payor selected financial service provider (40) via an electronic communication channel (14);
the payee input/output unit (20) comprising:
an own-data input part-unit (21);
a transaction-data management part-unit (22);
a data-unification part unit (23) having a first input (23a) connected to the own-data input part-unit (21), a second input (23b) connected to the transaction-data management part-unit (22), and an output operably connectable with the payee-data receiving part-unit (12) of the payor input/output unit (10) via a directed communication channel (30); and
a data-receiving part-unit (25) connectable to the transaction processing unit (51) of the payee selected financial service provider (50) via an electronic communication channel (26).

6. The transaction system according to claim 5 wherein a data encryption unit is operably associated with each input/output unit (10, 20).

7. The transaction system according to claim 5 wherein the own-data input part-unit (11) of the payor input/output unit (10) comprises an own-data register (11a) for storing inputted payor identification data (1a).

8. The transaction system according to claim 5 wherein the own-data input part-unit (21) of the payee input/output unit (20) comprises an own-data register (21a) for storing inputted payee identification data (2a).

9. The transaction system according to claim 5 wherein the transaction-data management part-unit (22) of the payee input/output unit (20) has a transaction identifier producing module (27).

10. The transaction system according to claim 5 wherein the payee input/output unit (20) has a payee-data receiving part-unit (28).

11. The transaction system according to claim 5 wherein the payor input/output unit (10) includes an information-receiving part-unit (15) for receiving data from the transaction processing unit (41) of the payor selected financial service provider (40).

12. The transaction system according to claim 5 wherein one or more data centers (61, 62) are present in the communication network (60), and all data centers (61, 62) are equipped with communication means (61a, 62a) for receiving, processing and forwarding information.

13. The transaction system according to claim 5 wherein a data transmission and operation-performing unit (71) for receiving, processing and forwarding information is present in the communication network (60), and the data-transmission and operation-performing unit (71) is linked to an accounting bank (70).

14. The transaction system according to claim 11 wherein the transaction processing unit (41) of the payor selected financial service provider (40) and the transaction processing unit (51) of the payee selected financial service provider (50) coincide.

15. A transaction processing unit for electronically conducting a business transaction in real time between a payor and a payee, wherein the transaction processing unit is configured:
to receive electronically a transaction order comprising at least payor identification data, payee identification data and transaction value;
to identify a payee selected financial service provider based on the payee identification data;
to generate a transaction order processing report based on the transaction value and the payor identification data;
to establish an electronic communication channel with the payee selected financial service provider, and
to transmit electronically the transaction order processing report to the payee selected financial service provider over the communication channel.

16. A method for executing a real-time electronic transaction between a payor and a payee which comprises the steps of:
establishing an electronic communication network among the payor, the payee, and at least one financial service provider;
generating an electronic transaction order which includes transaction value and payee identification information;
transmitting electronically the generated transaction order directly to a financial service provider selected from said at least one financial service provider over the electronic communication network;
processing the transaction order at the selected financial service provider; and
thereafter transmitting electronically a result based on said processing directly from the selected financial service provider to a member of the group consisting of payee and payee's designee, utilizing the electronic communication network.

17. The method according to claim 16 wherein the electronic transaction order is generated by the payee based on information provided by the payor directly to the financial service provider selected by the payor.

18. The method according to claim 17 wherein the electronic transaction order generated by the payor includes identification of a payee selected financial service provider.

19. The method according to claim 16 wherein the electronic transaction order is encrypted prior to transmission.
